(19) United States
(12) Patent Application Publication
(10) Pub. No.: US 2013/0085962 A1
(43) Pub. Date: Apr. 4, 2013

(54) SYSTEM AND METHOD FOR GENERATING VISUAL MODELS FROM ACTIVITY BASED MODELING DATA

(71) Applicant: NO MAGIC, INC., Allen, TX (US)

(72) Inventors: Gary Duncanson, Lucas, TX (US); Gerald Measzell, Frisco, TX (US); Kyle Wippert-Martinez, Plano, TX (US); David Forrest, Rowlett, TX (US); Sergio Loza, Lewisville, TX (US)

(73) Assignee: NO MAGIC, INC., Allen, TX (US)

(21) Appl. No.: 13/625,639

(22) Filed: Sep. 24, 2012

Related U.S. Application Data
(60) Provisional application No. 61/538,592, filed on Sep. 23, 2011.

(51) Int. Cl. G06Q 10/06

(52) U.S. Cl. CPC G06Q 10/067
USPC 705/348

(57) ABSTRACT

A system and method for translating activity based modeling into visual modeling may include storing activity based modeling data. The activity based modeling data may be read. A user may be enabled to classify data as elements of an activity based model. A visual model may be generated based on the classified data of the activity based modeling data. The visual model of the classified data of the activity based modeling data may be generated.

### RELATED APPLICATIONS

This Application claims priority to co-pending U.S. Provisional Patent Application Ser. No. 61/538,592 filed Sep. 23, 2011; the contents of which are incorporated herein by reference in their entirety.

### BACKGROUND

Activity based modeling is used by management of organizations, such as manufacturing companies, financial institutions, contractors, and governmental agencies, to examine costs for the organizations in producing goods and/or services. There are a number of activity based models that are used. One popular activity based model is the Consortium of Advanced Management—International (CAM-I) Model. Activity based costing (ABC) modeling and activity based management (ABM) modeling are concepts that are used by the CAM-I model. Activity-based costing is a methodology that measures the cost and performance of cost objects, activities, and resources. Cost objects consume activities and activities consume resources. Resource costs are assigned to activities through resource drivers based on their use of those drivers, and activity costs are reassigned to cost objects (outputs) through activity drivers based on the cost objects' proportional use of those activities. Activity-based costing incorporates causal relationships (i) between cost objects and activities and (ii) between activities and resources. As understood in the art, resources include people, materials, and machinery, for example, for producing goods, while activities include operations that use the resources to produce the goods.

FIG. 1 shows a graphical representation of the CAM-I Activity Based Costing Management (ABCM) Model 100 as developed in the 1980s and published in 1990. As shown, the CAM-I ABCM Model 100 includes a cost assignment view (vertical rectangle) 102 and a process view (horizontal rectangle) 104 that form a cross, where “activities” 106 meet at the intersection of the cost assignment and process views 102 and 104. Along the y-axis 108 (i.e., cost assignment view 102) is the activity based costing modeling (i.e., what things cost), while along the x-axis 110 is the activity based management modeling (i.e., why things cost). By performing activity based costing modeling, a number of different decision making analyses may result, including (i) senior management buy-in, (ii) profitability analysis, (iii) product costing/pricing, (iv) channel/customer analysis, and (v) make vs. buy. By performing activity based management modeling, a number of different performance measures may be generated, including (i) cost reduction/waste elimination, (ii) process reengineering/management, (iii) cost of quality, (iv) increase productivity, and (v) continuous improvement.

With further regard to FIG. 1, the elements of the CAM-I Framework may be described, as follows:

Activities

Activities 106 are work performed by people, equipment, technologies, or facilities. Activities 106 are usually described by the “action-verb-adjective-noun” grammar convention. For example, what does an organization do? How does it make the objects it sells? Activities 106 can usually be defined as a set of tasks performed by an organization to produce something profitable or useful. To be useful, an activity must not be defined too broad or too shallow. If an activity is defined as “building a car,” for example, the size of processes involved would be too complex. Instead, the activities should be broken down into multiple activities. For example, to build a car, smaller tasks or activities are to be performed, such as “build the engine,” “build the car's body,” “add four tires,” etc. These smaller activities are much more feasible to model.

Resources

Resources 112 are economic elements applied or used in the performance of activities or to directly support cost objects. Resources 112 may include people, materials, supplies, equipment, technologies, and facilities. For example, in the activity of making a car, a resource would be the metal body of the car, seats and interior upholstery, electronics and wire for the dashboard, and parts for the engine. All of these would be resourced used by the activity of building a car.

Resource Drivers

Resource drivers 114 are one of the best quantitative measures of the frequency and intensity of demands placed on a resource by other resources, activities, or cost objects. Resource drivers 114 are used to assign resource costs to activities 106, cost objects 122, or to other resources 112. The measurements used to link expense to the work activities performed by staff (e.g., the amount of time spent on an activity can be used to link salary expenses to it). A resource driver describes the resource cost assignment relationship between an activity and a cost object. The resource driver details how the resource and activity relates, including what percent of a resource pool is consumed by the related activity. For example, in the building a car scenario, the percentage of metal sheets used to create the body of a car describes the relationship between the resource, sheets of metal, and the activity, in this case building a car body.

Resource Cost Assignments

Resource cost assignments 116 provide the steps for assigning costs to resources as specified or directed by the resource drivers 114. The costs may be direct or indirect costs for utilization of each resource. For example, each of people, materials, supplies, equipment, technologies, and facilities have associated direct and indirect costs. In the activity of making a car, the metal body resource has a cost assigned thereto, seats and interior upholstery have costs assigned thereto, electronics and wire for the dashboard have costs assigned thereto, and parts for the engine have costs assigned thereto. All of these costs assignments for the resources are used in determining direct and indirect costs for building a car, and can help the manufacturer of the car better determine and monitor the costs of building the car.

Activity Drivers

Activity drivers 118 are one of the best quantitative measures of the frequency and intensity of the demands placed on an activity by cost objects or other activities. Activity drivers 118 are used to assign activity costs to cost objects or to other activities. An activity driver describes or defines the activity cost assignment relationship between an activity and a cost object. The activity drivers 118 details how the activity and cost object relates, including what percent of an activity cost drives the related cost object's production. For example, in the car building scenario, the percentage of cars are build into a certain model describes the relationship between the activity, in this case building cars, and the cost object, in this case a certain produced model of car.

Activity Cost Assignments

Activity cost assignments 120 provide the steps for assigning costs to activities as specified or directed by the activity drivers 118. The costs may be direct or indirect costs for the activities 106. For example, each of the activities for building a car may have a direct (e.g., labor, machines, materials) and indirect (e.g., labor overhead, electricity) costs allocated thereto so that the manufacturer can quantify costs for performing each activity in the activity based costing model.

Cost Objects

Cost objects 122 are any outputs, such as products, services, customer, contract, project, process, or other item for which a separate cost measurement may be desired as an output of the activity based cost modeling to enable someone to view. For the car building example, cost objects may include manufactured car, labor, scrap metal, shipping, machine usage, and so forth.

Cost Drivers

Cost drivers 124 describe any situation or event that causes a change in the consumption of a resource, or influences quality or cycle time. Activities 106 may have multiple cost drivers. Cost drivers do not necessarily need to be quantified, but strongly influence the selection and magnitude of resource drivers 114 and activity drivers 118. In the car building example, cost drivers 124 may include cost of metal, cost of energy, cost of labor, and so forth.

Performance Measures

Performance measures 126 are indicators of the work performed and the results achieved in an activity, process, or organizational unit. Performance measures 126 are both non-financial (e.g., efficiency, time, etc.) and financial (direct and indirect cost). Performance measures 126 enable periodic comparisons and benchmarking to enable someone to analyze the performance of activities and an organization. For the car building example, performance measures 126 may include the amount of time it takes to build the car (or any component of the car), the amount of resources (e.g., number of people directly and indirectly involved) used in building the car, and so forth.

As understood in the art, modeling is often performed using spreadsheet software programs, such as Microsoft Excel®, by personnel entering in data that represents real-world operations. For example, in the case of a manufacturer, a spreadsheet may be created to track manufacturing operations, including purchasing, staging, assembly, packaging, and shipping. In other words, sufficient detail to show end-to-end manufacturing operations, including infrastructure (e.g., machines used to perform manufacturing), labor, and materials, may be created and maintained in a spreadsheet so that management may have the ability to track statistics of the operations. Activity based modeling, such as the CAM-I model, was developed to help manage activities and costs of real-world operations in a standard manner so that metrics may be used when assessing results of the activities based modeling.

A problem that exists with using activity based modeling is that the spreadsheets can become quite large and complex for even moderate operations that are being modeled. As a result of the size and complexity of the models, management can have difficulty in understanding the details of the activity based model that are used to generate model output. In other words, while the activity based models may produce metrics that can be analyzed, the details of the model (e.g., data points that are used in constructing the model) can quickly become too detailed for management to have time or knowledge to learn. Thus, while activity based models constructed in spreadsheets are beneficial for organizations in better understanding their cost of operations, there are limitations due to having limited tool sets with which management and other personnel have had to use in working with activity based models.

### SUMMARY

The principles of the present invention provide for the ability to translate activity based modeling into a visual model. As understood in the art, visual modeling tools are relatively simple to use and provide visualization to users, such as management, that is not possible with existing activity based modeling tools, such as Excel spreadsheets. One embodiment includes integrating a standardized general-purpose modeling language, such as unified modeling language (UML), as managed and created by the Object Management Group (OMG), with an activity based model. In one embodiment, the activity based model may be in the form of a spreadsheet, such as an Excel spreadsheet. A user may classify data elements in the activity based model as being particular objects, including cost objects (outputs of activities), activities, and resources of the activity based model. Once classified, the modeling language data elements may generate a visual model representative of the complex activity based model. As a result of creating a visual model, management may review the visual model, which tends to be easier than reviewing a complex spreadsheet. In one embodiment, the user may change data in the spreadsheet and the visual model may be automatically updated. Once in the visual model, rather than making changes in the spreadsheet, the user may perform standard modeling operations, such as changing conditions, inputs, rules, scenarios, and structures, as understood in the art in the visual model. From the visual model, a user may elect to write the modified activity based model data into a spreadsheet, either the original or new spreadsheet, in the same format as the original spreadsheet from which the activity based model data was read to create the visual model.

One embodiment of a system may include a storage unit configured to store activity based modeling data, and a processing unit in communication with the storage unit. The processing unit may be configured to read the activity based modeling data, enable a user to categorize classify data as elements of an activity based model, process the categorized data to generate a visual model based on the classified data of the activity based modeling data, and generate a report display the visual model of the categorized classified data of the activity based modeling data.

One embodiment of a method may include storing activity based modeling data. The activity based modeling data may be read. A user may be enabled to classify data as elements of an activity based model. A visual model may be generated based on the classified data of the activity based modeling data. The visual model of the classified data of the activity based modeling data may be generated.

Another embodiment of a system for transforming activity based modeling data into a visual model may include a storage unit configured to store activity based modeling data and a processing unit in communication with the storage unit. The processing unit may be configured to enable a user to select locations of elements of the activity based modeling data being stored, enable the user to classify each of the elements of the activity based modeling data, generate the visual model based on the defined locations and classifications of the elements of the activity based modeling data, and display the visual model. The processing unit may be further configured to display a graphical user interface that enables the user to select starting and ending rows and columns of the elements of the activity based modeling data. Additionally, selectable classifiers may be displayed to associate with each element being classified by the user. Once the visual model has been generated, a user interface may display a listing of activity elements for selection by a user to view activity elements and visual model elements associated with the selected activity element.

### BRIEF DESCRIPTION OF THE DRAWINGS

The present invention is illustrated by way of example, and not limitation, in the figures of the accompanying drawings, in which:

FIG. 1 is a diagram of the CAM-I ABCM Model published in 1990 by CAM-I;

FIG. 2 is a block diagram of an illustrative computer environment in which the principles of the present invention may operate;

FIG. 3 is a block diagram of an illustrative software configuration that provides for features and functionality in accordance with the principles of the present invention;

FIG. 4 is an illustration of an illustrative model driven costing environment showing (i) a spreadsheet containing an ABCM model, (ii) a visual model of the ABCM model, and (iii) model driven costing toolset used to transform the modeling data of the spreadsheet into the visual model;

FIGS. 5A and 5B are screen shots of illustrative user interfaces provided by an import wizard that enable a user (i) to add elements from a spreadsheet containing modeling data by identifying locations and (ii) to classify the elements for inclusion in a visual model;

FIG. 6 is a screen shot of another illustrative user interface of the import wizard that enables a user to import elements as established by the user interfaces of FIGS. 5A and 5B;

FIG. 7 is a screen shot of an illustrative visual model of ABCM modeling data imported from a spreadsheet;

FIG. 8 is a screen shot of an illustrative user interface that enables a user to view different portions of the visual model of FIG. 7 created from the ABCM modeling data imported from the spreadsheet;

FIG. 9 is a screen shot of illustrative charts representative of performance measurements output from the visual model of FIG. 7;

FIG. 10 is a screen shot of illustrative cost data produced by the visual model of FIG. 7; and

FIG. 11 is a flow diagram of an illustrative process used to provide for transforming activity based modeling to a visual model utilizing the principles of the present invention.

### DESCRIPTION

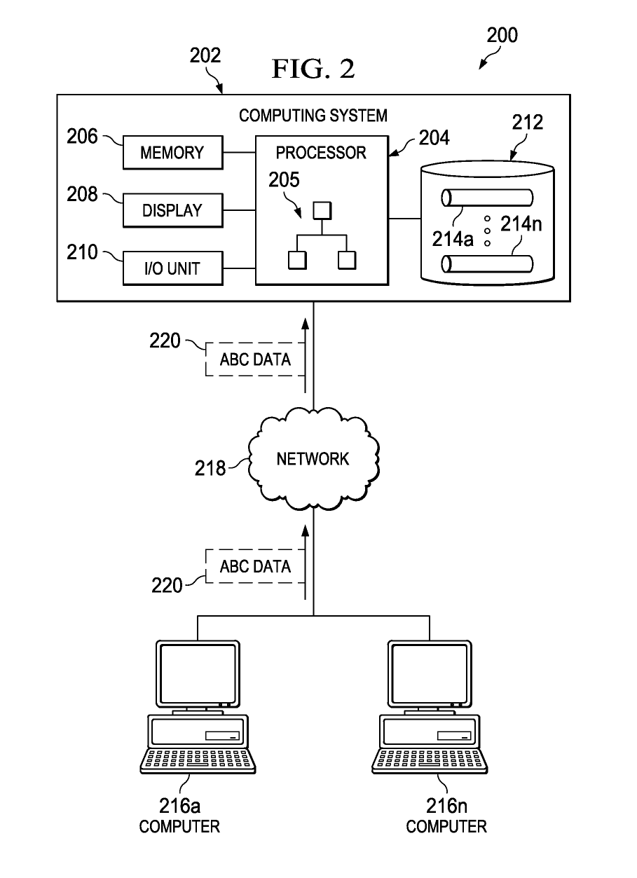

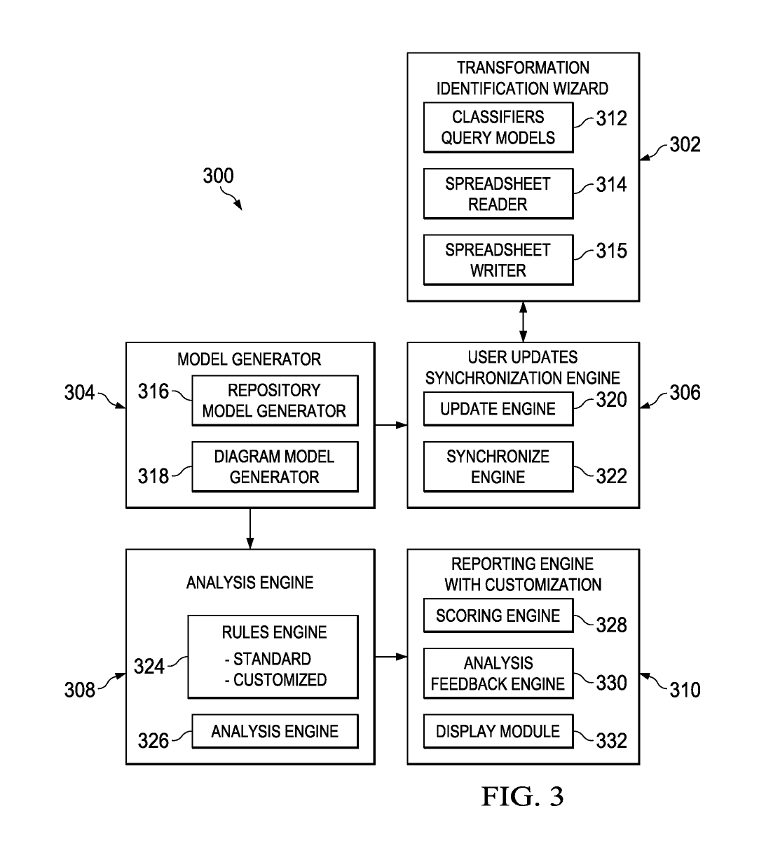

FIG. 2 is a block diagram of an illustrative computer environment 200 in which the principles of the present invention operate. The computer environment 200 includes a computing system 202 that includes a processing unit 204 that may include one or more computer processors. The processing unit 204 executes software 205 that performs the functions and functionality as provided in FIG. 3. The processing unit 206 may be in communication with a memory 206 that stores data and software instructions, display 208 capable of displaying data, input/output (I/O) unit 210 configured to communicate data to and from the computing system 202, and storage unit 212 that stores one or more data repositories 214a-214n (collectively 214). The data repositories 214 may store flat files or spreadsheets, such as Excel® spreadsheets, that includes activity based costing modeling and activity based management modeling data as defined by CAM-I. It should be understood that any other modeling, standard or non-standard, may be stored in the data repositories 214. In addition, the data repositories 214 may store visual model(s) that are translated from the ABCM modeling data being stored in the data repositories 214.

Computing systems 216a-216n (collectively 216) may be utilized in collecting ABCM modeling data. For example, the computing systems 216 may be operated within a company with several sites that perform the same or different functions in performing activities, which allow personnel and/or machines (e.g., automated manufacturing systems) to enter data locally into the computing system 216. In one embodiment, the processing unit 204 may communicate with the computing systems 216 via a communications network, such as the Internet or intranet, to collect ABCM data 220 and store the data 220 in one or more of the data repositories 214. In communicating, the processing unit 204 and computing system 216 may be configured to perform a push or pull arrangement via the I/O unit 210. Alternatively, the computing system 202 may be configured as an enterprise system such that computing systems 216 can access a data repository simultaneously. In one embodiment, the computing system 202 may be configured to operate in a software-as-a-service model, such that an organization does not itself control the computing system 202, but rather a third-party operator provides access to the computing system 202 and stores data in the data repositories 214 for each customer of the third-party seeking to translate activity based models into visual models. Still yet, users of the computers may have the visual modeling software operating on their respective computing systems 216 and ABCM modeling data may be accessed from centralized data repositories 214. It should be understood that the computing environment 200 may be configured in any manner to enable the user to collect and/or access ABCM data and translate and utilize image models, such as UML image models, representative of the activity based modeling data.

With regard to FIG. 3, a block diagram of an illustrative model driven costing toolset 300 may include a number of different modules, including a transformation identification wizard 302, model generator 304, user updates synchronization engine 306, analysis engine 308, and reporting engine with customization 310. Each of these modules 302-310 are used to translate and integrate activity based model data in the form of a spreadsheet or other data repository (e.g., flat file) with a visual model that may be an object-oriented model (e.g., UML model). As understood in the art, visual models are not simply graphical displays or outputs of results (e.g., charts, graphs, etc.), but rather provide for both visual representation and functionality (e.g., mathematical calculations and functional linkage representations (e.g., lines) between visual elements (e.g., boxes)). Although the activity based modeling described herein is a CAM-I model, it should be understood that any other costing, management, system, or other discipline modeling may be utilized in accordance with the principles of the present invention.

In addition, while the visual modeling described herein primarily utilizes OMG standardized visual modeling, which is supported by Magic Draw® produced by No Magic, Inc. of Allen, Tex., it should be understood that any visual modeling standards may be utilized. Such modeling standards may include, but not limited to, UML, SYSML, MODAF, DODAF, UPDM, NAF, MBSE, NIEM, or otherwise, as understood in the art. In one embodiment, foundational UML (OMG standard) may be utilized to execute a UML visual model (i.e., once the UML visual model is constructed, fUML may be utilized by a processing unit to execute the contents of the UML visual model). Other executable visual model standards, such as state chart XML (SCXML) as managed by the W3C organization, Action Language for Foundational UML (ALF), or any other executable visual model standards may be utilized for execution of a visual model. It should further be understood that the modules shown in FIG. 3 may be embodied in software and/or hardware that operate on a computing system, such as the computing system 202 of FIG. 2, and may have different configurations, including fewer, additional, or different modules that produce the same or analogous functionality as described herein.

Because the principles of the present invention provide for executing visual models, simulations using the visual models may also be established and executed. As understood in the art, simulations may vary inputs over a range and collect output data that varies in association with the inputs. In cases where multiple inputs vary, the inputs may be nested such that the inside input varies or steps through its full range and each successive input outside the inside input may step by one to allow the inside input variable(s) to sweep a full range until every input variable is swept through its entire range and all combinations of ranges are tested assuming no conditions stop the looping. In one embodiment, the simulation may be a Monte-Carlo simulation. In an alternative embodiment, a regressions analysis, such as a multivariate regression analysis, may be utilized to analyze model performance parameters. Additionally, variable parameter inputs may be applied to the inputs, as understood in the art. It should be understood that a variety of different simulation and analysis standards may be utilized in accordance with the principles of the present invention. Resulting from the execution of the simulations, optimized solutions of inputs and model elements may be determined. For example, least cost, highest output, fastest output, fewest hours, and so forth may be determined by using simulation analysis on the visual model. To set up the simulation, the principles of the present invention contemplate utilizing importation wizard to enable a user to set ranges for elements, such as resources (e.g., set quantity ranges, cost ranges, number of shifts, and so forth). An “execute” soft-button on the wizard graphical user interface may be provided to the user to initiate execution of the simulation.

The transformation identification wizard 302 is shown to include three sub-modules, including a classifiers query models module 312, spreadsheet reader module 314, and spreadsheet writer module 315. The classifiers query models module 312 operates to query or otherwise enable a user to identify and classify data in an activity based model dataset (e.g., select spreadsheet cells), as further described hereinbelow. In one embodiment, the module 312 may be configured to create a dataset that identifies locations in the spreadsheet of classified objects. The spreadsheet reader module 314 may be configured to read data as identified by the user from a spreadsheet that includes activity based model data. The reader module 314 may enable the user to select a spreadsheet, sheet within the spreadsheet, and cells within the sheet of the spreadsheet for any given classifier (e.g., “resources”). It should be understood that the data may be stored in any data repository, flat file or otherwise, and that the spreadsheet reader module 314 may read data in any format in which the data is being stored. In addition to reading the data, the reader module 314 may be configured to create a dataset that associates model data classifications (e.g., “resources,” “resource cost assignments,” “activities,” activity cost assignments,” “cost objects”) with locations, such as spreadsheet rows and columns, within the data repository. The spreadsheet writer module 315 may be configured to export data entered or modified in a graphical model generated by the model driven costing toolset 300. In one embodiment, the module 315 writes to a new spreadsheet (i.e., different from the one that was read by the spreadsheet reader module 314) so as to allow the original ABCM modeling data to be maintained.

The model generator 304 may include a repository model generator module 316 and diagram model generator module 318. The repository model generator 316 may be configured to generate and store a model in a repository (e.g., database) for use with the visual model. In one embodiment, the repository model generator 316 creates proper links between the identified data of the activity based model in the spreadsheet and the visual model of the activity based model. The module 316 may access rules that define the particular visual model (e.g., UML) being created and use those rules in constructing the visual model. The diagram model generator module 318 may be configured to create data for use in creating a graphical or visual representation or diagram model of the activity based model. In one embodiment, the module 318 may create and store the actual graphics used for displaying the activity based model data read from the repository in a graphical format. The graphics may include boxes and connector lines, for example. In an alternative embodiment, the module 318 may access data created by the repository model generator 316. Alternative visual objects may be created for use in displaying a visual model of the activity based model in accordance with the principles of the present invention.

The user updates synchronization engine 306 may include an update engine module 320 and synchronization engine module 322. The update engine module 320 may be configured to enable a user to make updates to the activity based model in the spreadsheet or visual model, and have the visual model updated automatically or in response to a user selected action (e.g., “update spreadsheet/visual model” soft-button on a graphical user interface). The synchronization engine module 322 may be configured to synchronize the activity based model with the visual model. In one embodiment, the module 322 may be configured to update the visual model, as created by the model generator 304, in response to the activity based model being updated (e.g., change data in the spreadsheet), and/or update the activity based model in response to the visual model being updated (e.g., change data in the visual model). In one embodiment, the synchronization is performed substantially real-time (i.e., almost instantaneously).

The analysis engine 308 may include a rules engine module 324 and an analysis engine module 326. The rules engine 324 may be configured to perform both standard and customized rules. The standard rules may include performing rules that are standard for CAM-I modeling, for example. Any other model rules standards for a particular industry or company may be utilized in accordance with the principles of the present invention. Customized rules may include rules that have been customized for a particular company or even for a particular model (e.g., proprietary model). The analysis engine module 326 may be configured to perform a metrics analysis, which may include statistical, logical, mathematical, or other analysis. As an example, a complexity analyzer may be configured to determine complexity of models, such as processes and costs. The complexity analyzer may determine complexity of yields, mean time between failures, and other business metrics, as understood in the art. The analysis engine module 326 may utilize conventional and/or customized analysis algorithms and tools for assessing an activity based model, in this case, from the visual model. From the analysis engine module 326, data may be generated that may be used to create charts, graphs, or other numerical or graphical representation, as understood in the art.

The reporting engine with customization module 310 may include a scoring engine module 328, analysis feedback engine module 330, and display module 332. The scoring engine module 328 may be configured to produce scores for various metrics of the activity based model. The scores may include results from the analysis engine 326, for example, or generate scores that are a combination of results from the analysis engine 326. Still yet, the scores may be generated independent of results from the analysis engine 326, such as producing probability distributions or any other metric that may be of interest to a user of the activity based model. The analysis feedback engine module 330 may be configured to generate feedback to a user that is viewing the report. The module 330 may generate feedback from data generated by the analysis engine module 326. The display module 332 may be configured to display and/or create a report for printing and/or displaying on an electronic display. In one embodiment, the module 332 may display a “dashboard” that displays standard or selectable metrics for a user based on the underlying activity based model and data contained therein.

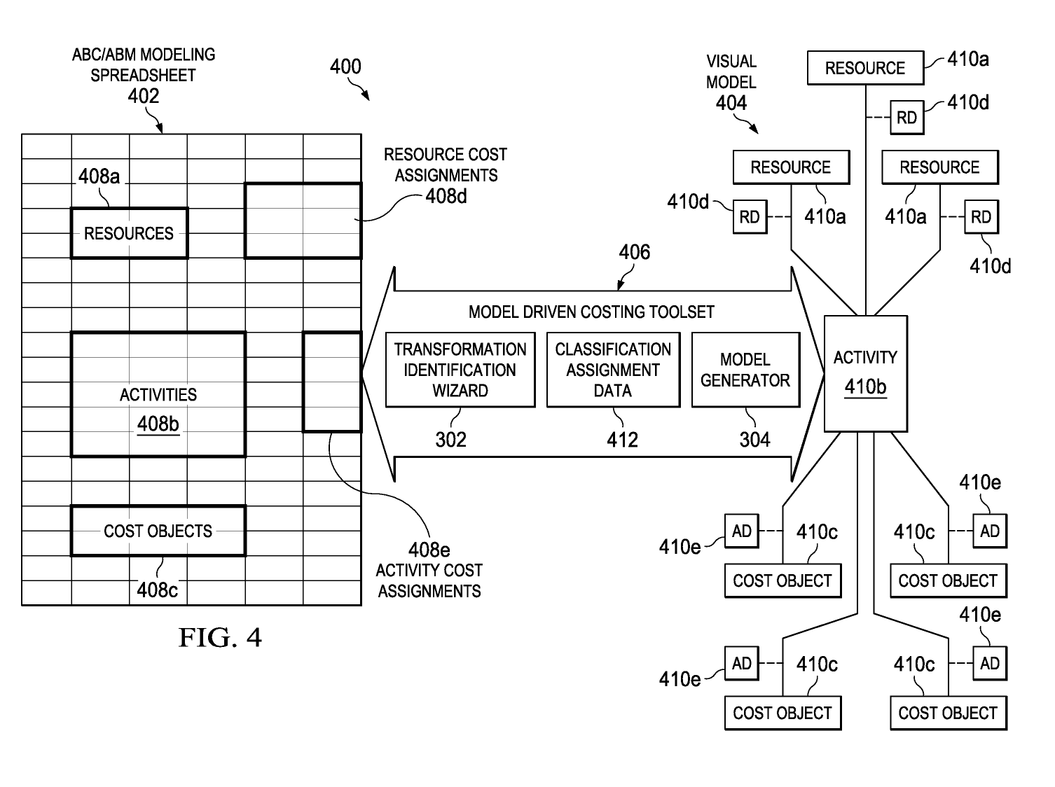

With regard to FIG. 4, an illustrative model driven costing environment 400 showing (i) a spreadsheet 402 containing a CAM-I ABCM model, (ii) a visual model 404 of the ABCM model, and (iii) model driven costing toolset 406 used to transform the modeling data of the spreadsheet 402 into the visual model 404. As shown, the spreadsheet 402 may include a number of cells that contain data of the different classifications 408a-408e of the ABCM model, while the visual model 404 may include visual model representations of the different classifications 410a-410e of the ABCM model. In one embodiment, the resource cost assignments 408d in the spreadsheet 402 may be translated into resource drivers 410d in the visual model 404, and activity cost assignments 408e in the spreadsheet 402 may be translated into activity drivers 410e in the visual model 404.

The model driven costing toolset 406 may include the transformation identification wizard 302 and model generator 304. As previously described with regard to FIG. 3, the wizard 302 may be used to read the model data in the spreadsheet and assign classifiers to the data, and the model generator 304 may be used to generate a visual model containing the visual data according to the rules (e.g., UML modeling rules) of the model standard being used. The transformation identification wizard 302 may create classification assignment data 412 that identifies data locations, such as cells (i.e., rows and columns), in which model data, such as ABCM modeling data, reside in the data repository (e.g., spreadsheet). That is, rather than copying the data from the data repository, reference data along with classifiers identifying the type of data to which the reference data is pointing, may be created and stored so as to minimize the amount of data that is being created and stored (i.e., not copying the actual ABCM data, but rather point to it). The model generator 304 may used the classifier assignment data 412 to access the model data in the data repository to populate the visual model using rules of the visual model standard. In the reverse direction, the transformation identification wizard may use the classification assignment data 412 to store data from the visual model back into the original spreadsheet 402 or into a new spreadsheet using the same format (e.g., same worksheets and locations of model data in the worksheets) as the original spreadsheet.

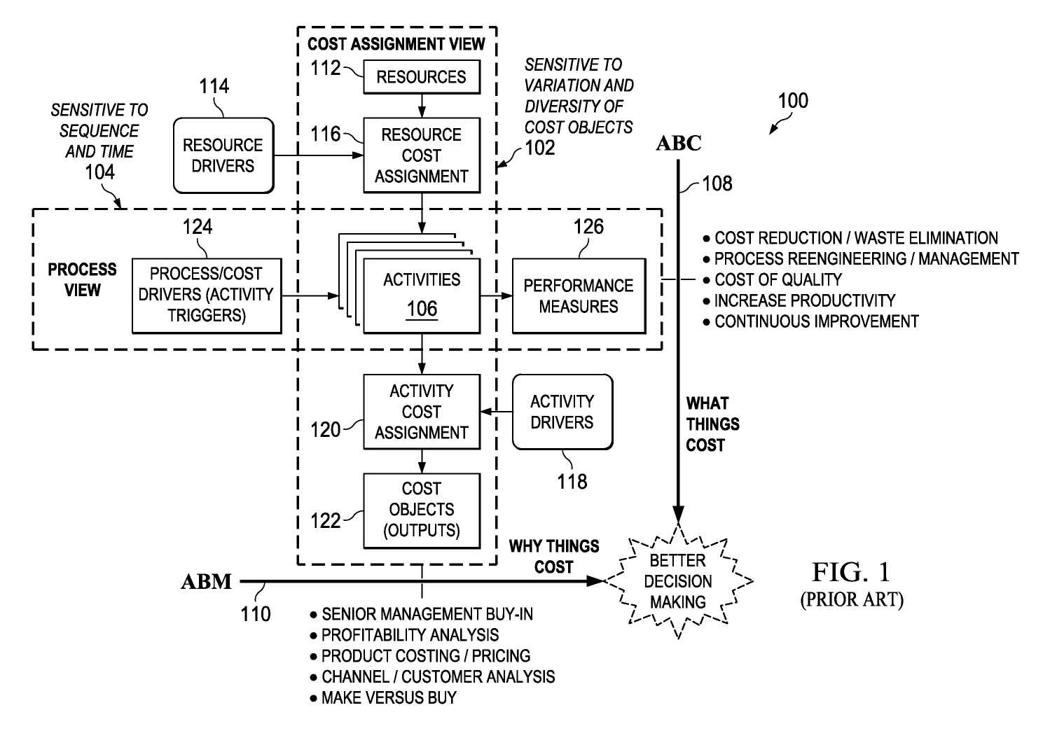

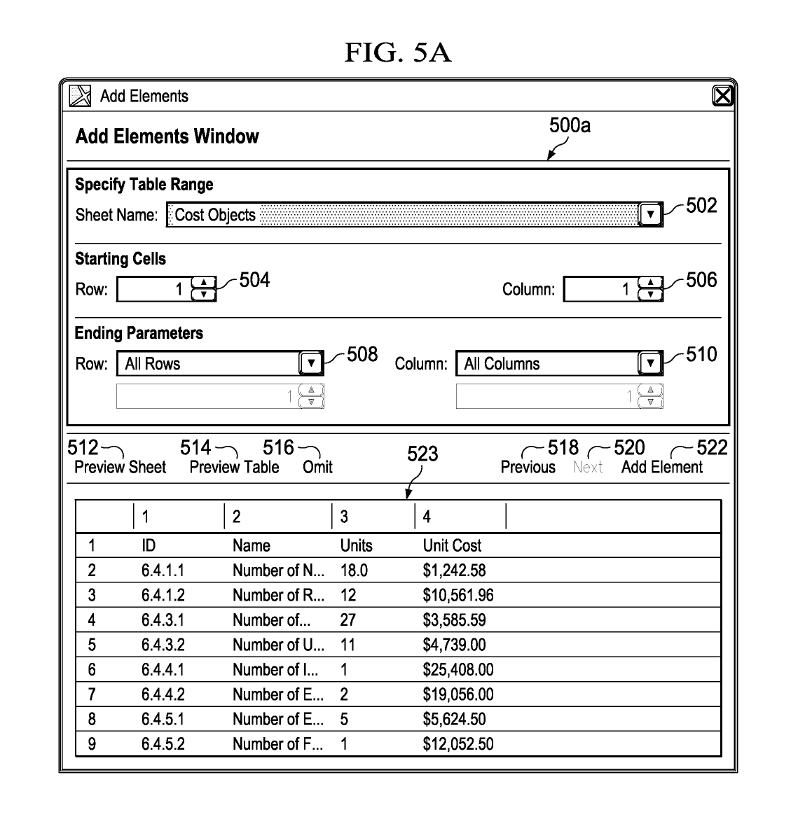

With regard to FIGS. 5A and 5B, screen shots of illustrative user interfaces 500a and 500b provided by an import wizard that enable a user (i) to add modeling elements from a spreadsheet containing modeling data by identifying locations and (ii) to classify the modeling elements for inclusion in a visual model are shown. The modeling elements may be any of the ABCM modeling elements, including “Resources,” “Resource Cost Assignment,” “Activities,” “Activity Cost Assignment,” “Cost Objects,” and “Process/Cost Drivers,” as described with regard to FIG. 1. In FIG. 5A, in adding elements from the spreadsheet, the user interface 500a includes a drop-down entry field 502 that enables the user to select a sheet, in this case “Cost Objects” sheet, from a spreadsheet that may include one or more sheets or worksheets. The wizard further enables a user to enter or select rows and columns of starting cells in entry fields or GUI elements 504 and 506, respectively. Ending parameters entry fields 508 and 510 allow for a user to select an ending row and column by selecting from a number of different options, such as “All Rows” and “All Columns,” “One Blank Row/Column,” “Two Consecutive Blank Rows/Columns,” “Different Font,” “Color Change,” “Bold Text Change,” or any other delimiter that may provide for automatic determination as to where the last row and/or column of a modeling element is to be determined.

The user interface 500a further includes a number of soft-buttons, including “Preview Sheet” soft-button 512, “Preview Table” soft-button 514, “Omit” soft-button, “Previous” soft-button 518, “Next” soft-button 520, and “Add Element” soft-button. In response to selecting the “Preview Sheet” soft-button 512, a worksheet 523 of the spreadsheet may be displayed in a viewing area, in this case at the bottom, on the user interface 500a. Similarly, in response to the user selecting the “Preview Table” soft-button 514, a table or element selection previously classified on the spreadsheet may be displayed in the viewing area. If the user has not selected a sheet or element within the sheet, the soft-buttons 512 and 514 may remain inactive or inoperative. The “Omit” soft-button 516 may enable the user to select rows from the previewed sheet 523 by using a pointing device, such as a computer mouse, or any other input mechanism as understood in the art, thereby allowing the user to omit one or more rows of data or text from the modeling data. The “Previous” soft-button 518 is shown to be “grayed out,” which indicates that the user interface 500a is the first user interface of the input wizard, so that the user cannot go back to a previous user interface. After the user selects or enters the starting and ending parameters and optionally omits data that he or she decides not to include as part of the modeling element, the user may select the “Next” soft-button 520 to enable the next user interface of the input wizard to be displayed. The “Add Element” soft-button 522 is also “grayed-out” as the user has not assigned a modeling element classifier to the selected modeling element data from the spreadsheet, which is to be performed at the next user interface, as presented in FIG. 5B.

As shown in FIG. 5B, the user interface 500b enables the user to select a “CAM-I Type” or category of the modeling element specified in the user interface 500a of FIG. 5A. The classifiers or categories may include classifiers 526a-526f, including “Resource,” “Activity,” “Activity Driver,” “Cost Object,” “Process Driver,” “Resource,” and “Resource Driver.” It should be understood that another cost model may utilize different classifiers than those of CAM-I. In this case, the user has selected classifier “Resource” 526e. The selected classifier may be assigned to a column 528 within the data or table classified in user interface 500a and assigned a classifier type, such as “cost,” “ID,” and “name.” As with the user interface 500a, soft-buttons “Preview Sheet” 532, “Preview Table” 534, “Omit” 536, “Previous” 538, “Next” 540, and “Add Element” 542 are available for the user to select to cause the user interface 500b to perform the respective functions, as previously described. As an example, in response to selecting “Preview Table” soft-button 534, a table or selected data 544, as performed by the user using user interface 500a, may be displayed at the bottom of the user interface 500b.

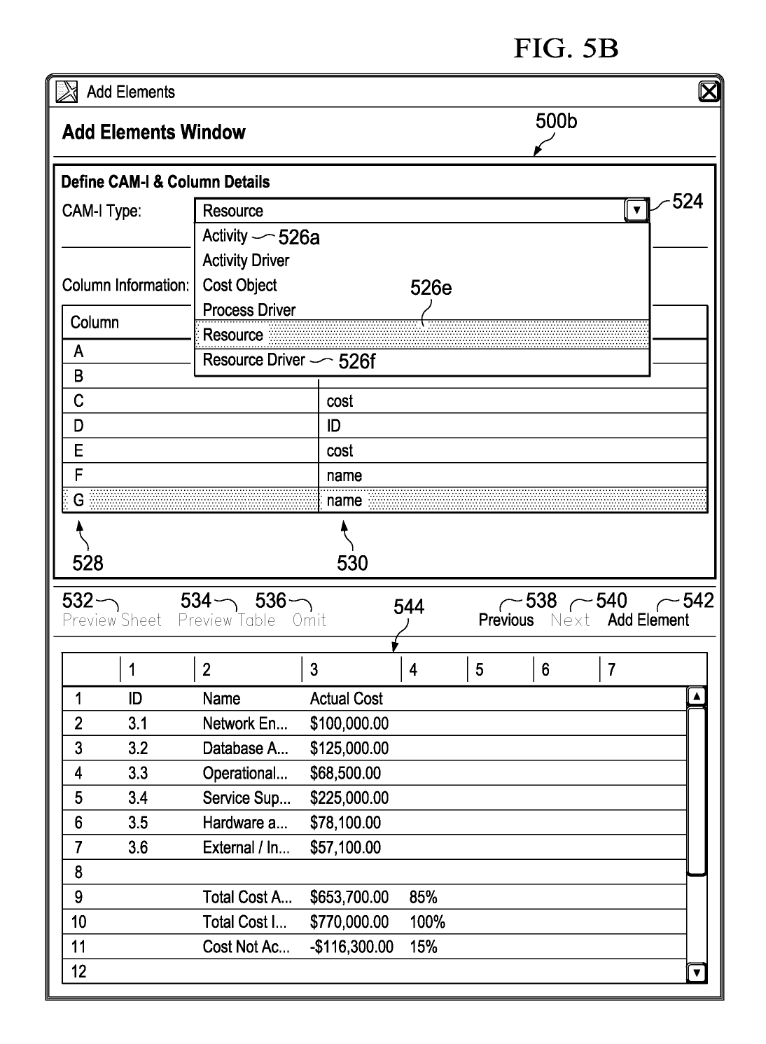

With regard to FIG. 6, a screen shot of another illustrative user interface 600 of the import wizard that enables a user to import elements as established by the user interfaces of FIGS. 5A and 5B is shown. A “Select Excel File” data entry field 602 may enable a user to select or enter a location/name of an Excel® spreadsheet from a local or remotely located storage unit (e.g., disk drive). The user may select whether the elements reference one another by selecting either a “Cell Reference” or “ID Reference” soft-button 604. A listing or table of elements to import from the selected Excel file may be presented in table 606. As shown, a number of different information elements, including “CAM-I Type,” “Sheet Name,” “Starting Row,” “Starting Column,” “Ending Row Parameter,” and “Ending Column Parameter,” that were previously specified by the user in user interfaces 500a and 500b. A couple of soft-buttons, including “Find Elements” 608, “Remove Element(s)” 610, and “Import” 612 enable the user to selectively (i) list and select data elements that were previously classified, (ii) remove elements from the table 606, and (iii) import the elements listed in the table to cause the elements to populate a visual model.

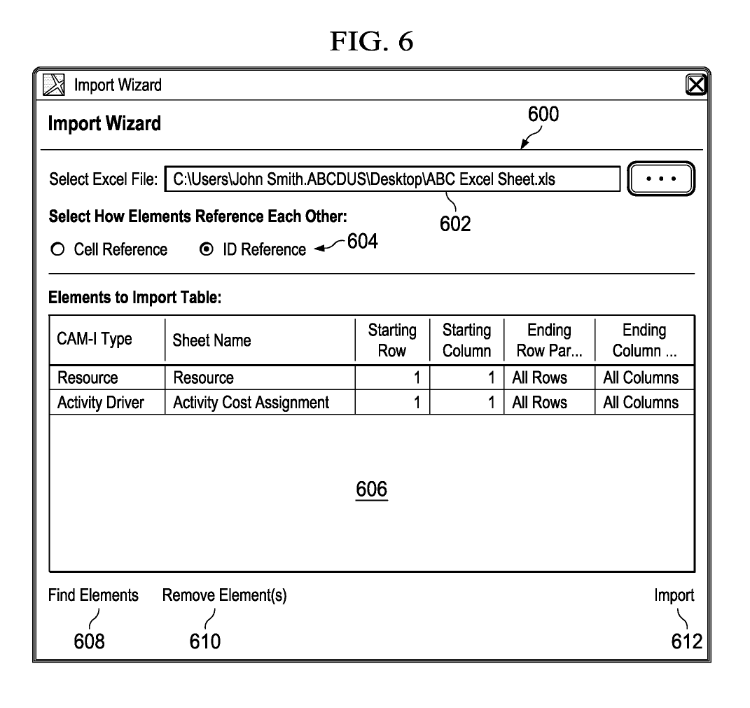

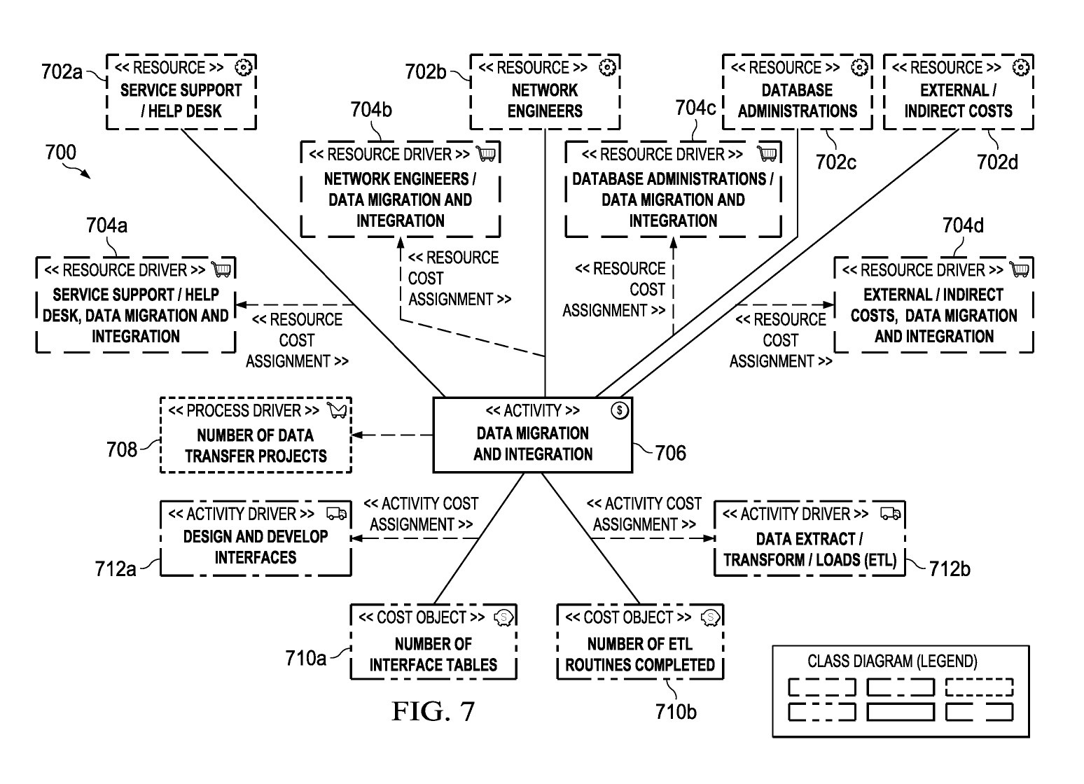

To better understand how the translation from an activity based model to a visual model may actually be performed, the following example is provided. Below in TABLES 1A-1G are illustrative worksheets from an illustrative spreadsheet that contains an activity based model. These worksheets may be used by a user to classify each of the elements of the activity based model so that the toolset may translate and correlate the elements contained therein to a visual model (see FIGS. 7 and 8).

TABLE 1A
All Resources in the Activity Based Model

| ID | Name | Actual Cost | |
|---|---|---|---|
| 3.1 | Network Engineers | $100,000.00 | |
| 3.2 | Database Administrations | $125,000.00 | |
| 3.3 | Operational Management | $68,500.00 | |
| 3.4 | Service Support/Help Desk | $225,000.00 | |
| 3.5 | Hardware and Equipment | $78,100.00 | |
| 3.6 | External/Indirect Costs | $57,100.00 | |
| | Total Cost Accounted For in this Model | $653,700.00 | 85% |
| | Total Cost Incurred for Baseline Period | $770,000.00 | 100% |
| | Cost Not Accounted For in this Model | $(116,300.00) | 15% |

TABLE 1B
All Resource Cost Assignments in the Activity Based Model

| | | | Amount of Resources |
|---|---|---|---|
| Resource Pool | Activity | % Allocated | Allocated to Each Activity |
| 3.1 | 4.1 | 25% | $25,000.00 |
| 3.1 | 4.2 | 35% | $35,000.00 |
| 3.1 | 4.3 | 5% | $5,000.00 |
| 3.1 | 4.4 | 10% | $10,000.00 |
| 3.1 | 4.5 | 20% | $20,000.00 |
| 3.1 | 4.6 | 5% | $5,000.00 |
| 3.2 | 4.3 | 85% | $106,250.00 |
| 3.2 | 4.4 | 9% | $11,250.00 |
| 3.2 | 4.5 | 5% | $6,250.00 |
| 3.2 | 4.6 | 1% | $1,250.00 |
| 3.3 | 4.1 | 10% | $6,850.00 |
| 3.3 | 4.2 | 20% | $13,700.00 |
| 3.3 | 4.3 | 10% | $6,850.00 |
| 3.3 | 4.5 | 15% | $10,275.00 |
| 3.3 | 4.6 | 45% | $30,825.00 |
| 3.4 | 4.1 | 17.67% | $39,750.00 |
| 3.4 | 4.2 | 65.78% | $148,000.00 |
| 3.4 | 4.3 | 2% | $3,800.00 |
| 3.4 | 4.4 | 13.24% | $29,799.99 |
| 3.4 | 4.5 | 1.62% | $3,650.00 |
| 3.5 | 4.1 | 70.0% | $54,670.00 |
| 3.5 | 4.2 | 5% | $3,905.00 |
| 3.5 | 4.3 | 20.0% | $15,620.00 |
| 3.5 | 4.4 | 5% | $3,905.00 |
| 3.6 | 4.1 | 40% | $22,840.00 |
| 3.6 | 4.2 | 10% | $5,710.00 |
| 3.6 | 4.3 | 20% | $11,420.00 |
| 3.6 | 4.4 | 15% | $8,565.00 |
| 3.6 | 4.5 | 15% | $8,565.00 |

TABLE 1C
All Activities in the Activity Based Model

| ID | Activity | Total Cost |
|---|---|---|
| 4.1 | Installation of Network Connections and Equipment | $149,110.00 |
| 4.2 | Trouble Shoot Network Connection Problems | $206,315.00 |
| 4.3 | Database Optimization and Maintenance | $148,940.00 |
| 4.4 | Data Migration and Integration | $63,519.99 |
| 4.5 | End User Reports and Programs | $40,175.00 |
| 4.6 | Strategic and Resource Management of Data | $37,075.00 |

TABLE 1D
All Activity Cost Assignments in the Activity Based Model

| | | | | Allocated |
|---|---|---|---|---|
| ID | Activity | Name | % | Cost |
| 6.4.1.1 | 4.1 | New Network Taps | 15% | $22,366.50 |
| 6.4.1.2 | 4.1 | Setup Local Area Networks - | 85% | $126,743.50 |
| | | Remote Sites | | |
| 6.4.3.1 | 4.3 | Routine Scheduled Maintenance | 65% | $96,811.00 |
| 6.4.3.2 | 4.3 | Unscheduled Fixes and Bugs | 35% | $52,129.00 |
| 6.4.4.1 | 4.4 | Design & Develop Interfaces | 40% | $25,408.00 |
| 6.4.4.2 | 4.4 | Data Extract/Transform/Loads | 60% | $38,111.99 |
| | | (ETL) | | |
| 6.4.5.1 | 4.5 | One Time Ad Hoc Requests | 70% | $28,122.50 |
| 6.4.5.2 | 4.5 | New Functional Procedure | 30% | $12,052.50 |

TABLE 1E
All Cost Objects in the Activity Based Model

| ID | Name | Units | Unit Cost |
|---|---|---|---|
| 6.4.1.1 | Number of New Taps | 18 | $1,242.58 |
| 6.4.1.2 | Number of Remote LAN Setups | 12 | $10,561.96 |
| 6.4.3.1 | Number of Maintenance Routines | 27 | $3,585.59 |
| 6.4.3.2 | Number of Unscheduled Action Events | 11 | $4,739.00 |
| 6.4.4.1 | Number of Interface Tables | 1 | $25,408.00 |
| 6.4.4.2 | Number of ETL Routines Completed | 2 | $19,056.00 |
| 6.4.5.1 | Number of End User Requests | 5 | $5,624.50 |
| 6.4.5.2 | Number of Functional Reworks | 1 | $12,052.50 |

TABLE 1F
All Process Drivers in the Activity Based Model

| | | | Cost Per |
|---|---|---|---|
| Activity | Name | Units | Unit |
| 4.1 | Number of Installations | 5 | $29,822.00 |
| 4.2 | Number of Help Desk Tickets | 135 | $1,528.26 |
| 4.3 | Number of Database Work Orders | 6 | $24,823.33 |
| 4.4 | Number of Data Transfer Projects | 2 | $31,760.00 |
| 4.5 | Number of User Development Requests | 2 | $20,087.50 |
| 4.6 | Number of Unique Data Repositories | 4 | $9,268.75 |

TABLE 1G
All Hourly Rates and Other Aggregated Statistics
per Activity in the Activity Based Model

| Activity | Hours per Unit | Total Volume | Total Hours | Cost Per Hour |
|---|---|---|---|---|
| 4.1 | 35 | 5 | 175 | $170.41 |
| 4.2 | 2 | 135 | 270 | $5.66 |
| 4.3 | 0 | 6 | 0 | $— |
| 4.4 | 0 | 2 | 0 | $— |
| 4.5 | 30 | 2 | 60 | $334.79 |
| 4.6 | 0 | 4 | 0 | $— |

For this example, the following definitions are utilized:

Direct Cost—Cost that are directly traceable to the project and charged to the project without allocations involved.

Drivers—The use of units, throughputs or some output that serves as the logical basis for allocating cost.

Indirect Cost—Cost not directly associated with a project, but allocated to reflect the fact that the project gets a benefit from the resource and should reflect some measure of its cost.

Period—Time periods used in the model such as one year or two quarters. The initial period used in the model is usually the previous fiscal year for baseline data and any periods thereafter are used for planning and budgeting in the current fiscal year.

Resource—Departmental assets (labor, equipment, etc.) that perform the work (activities).

Resource Driver—A basis for allocating resource costs to activities.

Resource Pool—A set of resources (labor, equipment, etc.) that collectively comes together so that the organization can execute on a service or activity.

Unit Cost—Total Activity Cost divided by Driver Volume. Unit Cost are often used for comparisons and benchmarking to reduce costs over time. Unit cost are also used for budgeting based on future expected.

With regard to FIG. 7, a screen shot of an illustrative visual model 700 of ABCM modeling data imported from a spreadsheet, each worksheet of the spreadsheet being provided in TABLES 1A-1G above, is shown. Due to the size of the text in each of the visual element (i.e., boxes), text from each of the visual elements are listed below in TABLES 2A-2F The visual model 700 includes the elements that were previously classified from the ABCM modeling data in the spreadsheet (i.e., TABLES 1A-1F). The visual model 700 is only a portion of the entire visual model, and includes a single activity and related elements (e.g., resources) of the activity based model. As shown, as a result of the elements being identified and classified from the ABCM data in the spreadsheet, four resource elements 702a-702d (collectively 702) (TABLE 2A), four resource drivers 704a-704d (collectively 704) (resulting from four resource cost assignments being classified) (TABLE 2B), one activity 706 (TABLE 2C), one process/cost driver 708 (TABLE 2D), two cost objects 710a and 710b (collectively 710) (TABLE 2E), and two activity drivers 712a and 712b (collectively 712) (TABLE 2F) (resulting from two activity cost assignments being made) are created in the visual model 700. For simplicity purposes, the principles of the present invention may create subsections of visual models that include one activity, in this case activity 706, for presentation to the user. It should be understood, however, that multiple activities may be included and presented in a visual model view, as well. In this example, six activity elements were initially defined in the activity based model, as shown in TABLE 1C.

More specifically, the translation that is made between the activity based model (spreadsheets in TABLES 1A-1G) and visual model (FIG. 7 and TABLES 2A-2F) use the various data fields in the spreadsheets in the process. In the instant example, the Activity 706 being presented is identified as ID 4.4 (“Data Migration and Integration”) in TABLE 1C Activities, which has an associated Total Cost of $63,519.99. From the Resource Cost Assignment element data (TABLE 1B, “Resource Cost Assignment”), Activity 4.4 is shown to be associated with a number of different resources from the “Resource Pool” column, including Resources with IDs 3.1, 3.2, 3.4, 3.5, and 3.6. From the Resource element data (TABLE 1A), the Resources that are being used by the Activity 4.4 are Network Engineers (3.1), Database Administrations (3.2), Service Support/Help Desk (3.4), Hardware and Equipment (3.5), and External/Indirect Costs (3.6). Each of these resources have associated Actual Costs (e.g., Network Engineers $100,000). The Actual Costs may be direct and/or indirect compensation for one or more network engineers. The Resource Cost Assignments shown what percentage of the Actual Costs are being applied to the Activity. In this example, 10% of Resource 3.1 (Network Engineers) are allocated to Activity 4.4 (“Data Migration and Integration Activity”), 9% of Resource 3.2 (Database Administrations) are allocated to Activity 4.4, 13.24% of Resource 3.4 (Service Support/Help Desk) are allocated to Activity 4.4, 5% of Resource 3.5 (Hardware and Equipment) are allocated to Activity 4.4, and 15% of Resource 3.6 (External/Indirect Costs) are allocated to Activity 4.4. A total cost of the activities is $63,519.99 is computed from these various allocations. The same or analogous modeling configuration may be made for the cost objects 710a and 710b (outputs or products being created by the activities) by using the activity cost assignments 712a-712b (TABLE 1E) to allocate percentages of activities (TABLE 1C) to respective cost objects 710a and 710b (TABLE 1D).

The visual model 700 shows boxes having, at least in part, editable fields for variables that can be adjusted, such as cost, allocation, an so on. Because the visual model 700 is interactive, the user may select a field by using a computer mouse or otherwise and revise the variables when working with the visual model 700. In an alternative embodiment, tables, such as TABLES 2A-2F, may be provided for the user to adjust the variables. Once adjusted, the system (i.e., computer on which the toolset is operating) may automatically or in response to a user request execute the visual model to show how the revisions to the variables affect other elements of the model. Once various parameters and metrics are established to be utilized in report(s), then the report(s) may be automatically updated. The user may save the updated visual model in a separate data repository from the original one created from the activity based model. In one embodiment, the user may translate the visual model back into an activity based model having the same configuration as the original activity based model as the configuration is known and stored by the wizard.

The text of the elements shown in FIG. 7 are provided below in TABLES 1A-1E:

TABLE 2A
Resources

| Reference | Type | Name | Cost | ID |
|---|---|---|---|---|
| 702a | Resource | Service Support/Help Desk: | $225,000 | 3.4 |
| | | Resource | | |
| 702b | Resource | Network Engineers: Resource | $100,000 | 3.1 |
| 702c | Resource | Database Administrations: | $125,000 | 3.2 |
| | | Resource | | |
| 702d | Resource | External/Indirect Costs: | $57,100 | 3.6 |
| | | Resource | | |

TABLE 2B
Resource Drivers

| | | | Amount | |
|---|---|---|---|---|
| Reference | Type | Name | Allocated | Percent |
| 704a | Resource Driver | Service Support/Help Desk, Data | $29,799.99 | 0.1324444 |
| | | Migration and Integration: Resource Driver | | |
| 704b | Resource Driver | Network Engineers, Data Migration and | $10,000 | 0.1 |
| | | Integration: Resource Driver | | |
| 704c | Resource Driver | Database Administrations, Data Migration | $11,250 | 0.09 |
| | | and Integration: Resource Driver | | |
| 704d | Resource Driver | External/Indirect Costs, Data Migration | $8,565 | 0.15 |
| | | and Integration: Resource Driver | | |

TABLE 2C
Activities

| Reference | Type | Name | Total Cost | ID |
|---|---|---|---|---|
| 706 | Activity | Data Migration and Integration: | $63,519.99 | 4.4 |
| | | Activity | | |

TABLE 2D
Process Driver

| Reference | Type | Name | Unit Cost | Units |
|---|---|---|---|---|
| 708 | Process | Number of Data Transfer | $31,759.995 | 2 |
| | Driver | Projects: Process Driver | | |

TABLE 2E
Cost Objects (Outputs)

| Reference | Type | Name | Unit Cost | Units | ID |
|---|---|---|---|---|---|
| 710a | Cost | Number of Interface | $25,407.996 | 1 | 6.4.4.1 |
| | Object | Tables: Cost Object | | | |
| 710b | Cost | Number of ETL | $19,055.997 | 2 | 6.4.4.2 |
| | Object | Routines | | | |
| | | Completed: Cost | | | |
| | | Object | | | |

TABLE 2F
Activity Drivers

| | | | Amount | |
|---|---|---|---|---|
| Reference | Type | Name | Allocated | Percent |
| 712a | Activity | Design & Develop | $25,407.996 | 0.4 |
| | Driver | Interfaces: Activity | | |
| | | Driver | | |
| 712b | Activity | Data Extract/Transform/ | $38,111.994 | 0.6 |
| | Driver | Loads (ETL): Activity | | |
| | | Driver | | |

FIG. 8 is a screen shot of an illustrative user interface 800 that enables a user to view different portions of the visual model of FIG. 7 created from the ABCM modeling data imported from the spreadsheet. As described above, six activity elements were initially defined. In the user interface 800, a portion 802 shows a folder listing of elements in the visual model in a hierarchical manner. The folders may include “Activity Diagrams,” “Activity Driver Pool,” “Activity Pool,” “Cost Object Pool,” “Process Driver Pool,” “Resource Driver Pool,” “Resource Pool,” and so on. As shown within the “Activity Diagrams,” a “links” folder may include six different classified element listings 804a-804f (collectively 804), each being inclusive of one of the six different classified activities by the user from the ABCM modeling data from the spreadsheet. A user may select each of the different listings 804 to view the respective activity and associated resources, resource drivers, activity drivers, cost objects, and process/cost drivers in the visual model format. As shown, one activity element 806 is shown to have a number of links extending therefrom that shows a visual model representation of the other elements that are related to that activity element 806.

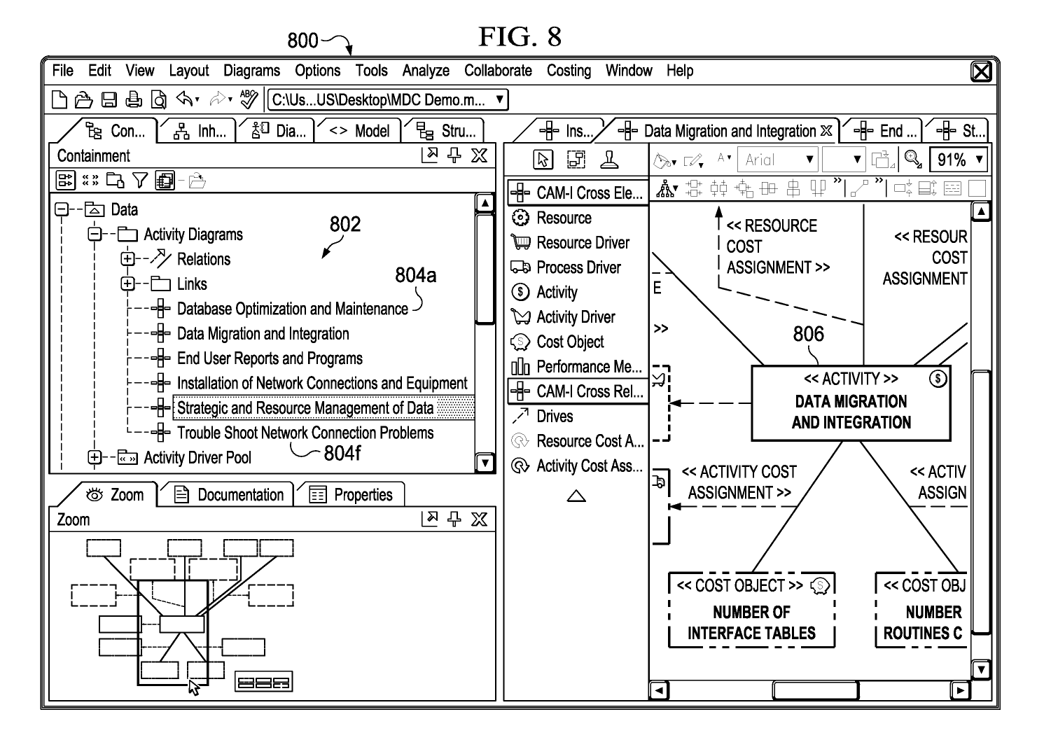

With regard to FIG. 9, a screen shot of illustrative charts 900 representative of performance measurements output from the visual model of FIG. 7 is shown. The charts 900 may include a pie chart 902, bar graph 904, and line graphs 906 and 908. Each of the charts are representative of resources utilized for each of the activities that are being performed for creation of a product (i.e., cost object). In one embodiment, a wizard may be utilized to enable the user to select which activities and/or objects to include in the report, process the data produced from the visual model (e.g., perform equations from each of the cells in the spreadsheet that populate the elements of the visual model, aggregate the data associated with the selected objects), and display the processed data on the graph(s). The types of graphs along with the object information to include on each of the graphs may be manually, semi-automatically, or automatically selected by a user and/or the system executing the toolset.

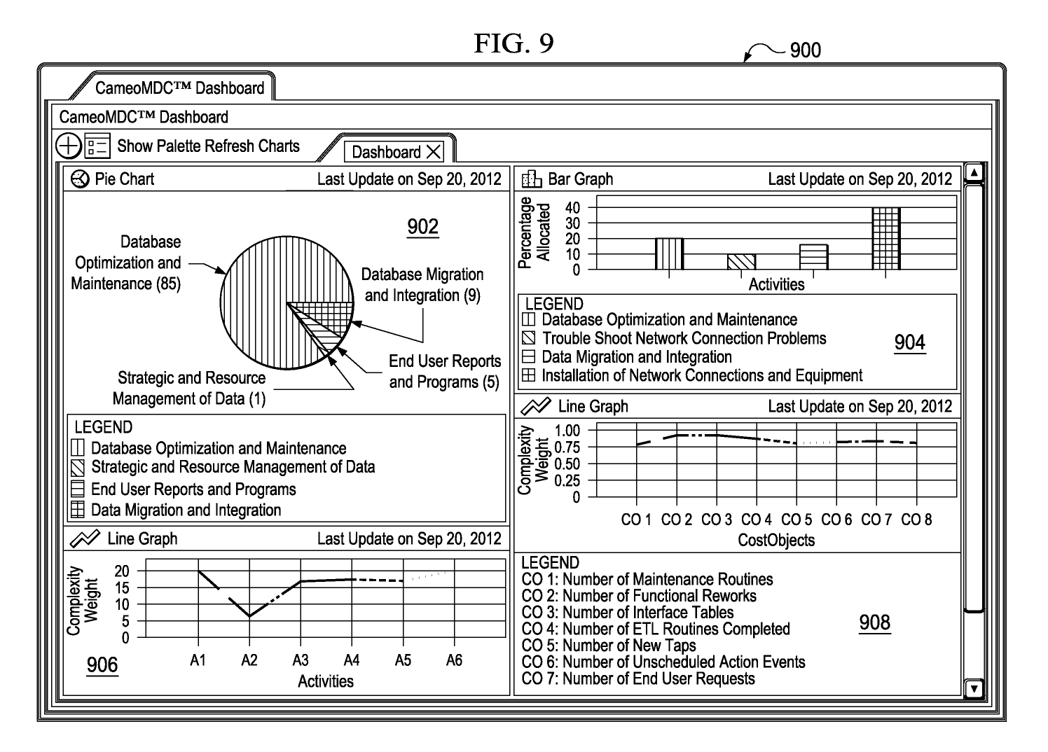

With regard to FIG. 10, a screen shot of illustrative cost data 1000 produced by the visual model of FIG. 7 is shown. Cost data may be processed in a variety of selectable ways and based on a variety of selectable factors. Each of the objects includes a cost associated therewith. For example, each resource object includes an associated cost, each activity includes an associated cost, and each cost object includes an associated cost. It should be understood that the costs may include direct and indirect costs. Costs may be processed to include statistics, such as average cost, median cost, highest cost, and so forth. Below are example reports that may be generated:

The following information may be reported for each Activity instance:

Activity Cost: The report may have the following collective activity analysis with respect to the associated Activity Costs: (i) most expensive resource; (ii) least expensive activity; and (iii) top 3 activities with highest cost.

Resource: The report may have the following collective activity analysis with respect to the associated Resources: (i) activities that are associated with the most resources; (ii) activities that are associated with the least amount of resources; and (iii) activities that share the most resources.

Resource Driver: The report may have the following collective activity analysis with respect to the associated Resource Drivers: (i) activity with the highest deviation of resource allocation; and (ii) activity with the least deviation of resource allocation.

Cost Object: The report may have the following collective activity analysis with respect to the associated cost objects: (i) activities with no cost objects; (ii) activity with the highest number of cost objects ; and (iii) activity with the least number of cost objects.

Activity Driver: The report will have the following collective activity analysis with respect to the associated activity drivers: (i) activity with the highest deviation of cost allocation percentage; (ii) activity with the least deviation of cost allocation.

It should be understood that any cost data in any format related to any object in the visual model may be included in an activity report. As shown in FIG. 10, four cost elements are provided, including “Resource with highest average Activity Cost” 1002, “Resource with lowest average Activity Cost” 1004, “Average resource Cost” 1006, and “Average Cost Deviation” 1008.

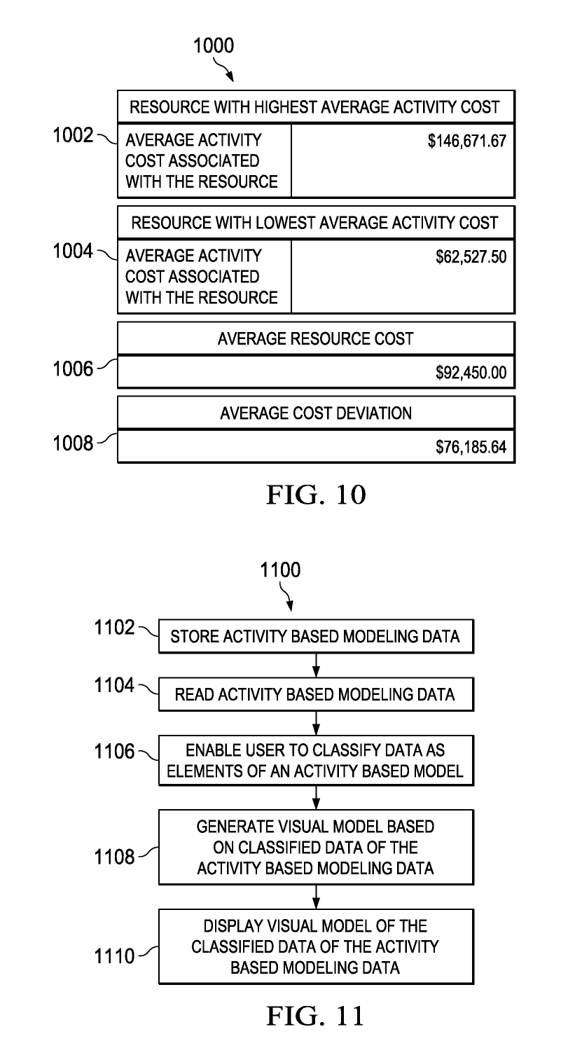

FIG. 11 is a flow diagram of an illustrative process 1100 used to provide for transforming activity based modeling to a visual model utilizing the principles of the present invention. The process 1100 may start at step 1102, where activity based modeling data may be stored. The storage of the activity based modeling data may be in a spreadsheet, such as a Microsoft Excel® spreadsheet. It should be understood that any data format may be utilized for storing the activity based modeling data in accordance with the principles of the present invention.

At step 1104, the activity based modeling data may be read. In reading the activity based modeling data, the data may be read in its native format (e.g., Microsoft Excel®). At step 1106, a user may be enabled to classify data as elements of an activity based model. In classifying the data, the user may select from a list of possible data elements of an activity based model. If the activity based model is defined by CAM-I ABCM modeling, then the list may include resources, resource cost assignment, activities, activity cost assignment, cost objects, and process/cost drivers. It should be understood that any other cost based modeling may be utilized in accordance with the principles of the present invention and the elements of those other cost based modeling may be provided to the user for selection to classify the elements.

At step 1108, a visual model may be generated based on the classified data of the activity based modeling data. In generating the visual model, rules that define the visual model may be utilized. The rules may define a standard visual model, such as UML. Alternative visual models may be utilized. In one embodiment, a modified visual modeling standard may be utilized (i.e., the primary concepts of a visual modeling standard with minor modifications). At step 1110, the visual model of the classified data of the activity based modeling data may be displayed. In displaying the visual model, the entire model may be displayed or a portion of the visual model may be displayed. In one embodiment, each activity element along with corresponding elements (e.g., resources, resource drivers, cost objects, and activity drivers) may be displayed.

In addition to displaying the visual model, the visual model may be executed by a processing unit to calculate the values of each of the elements. That is, where the visual model has populated equations from the activity based model from a spreadsheet, for example, the processing unit may execute the equations in the visual model. A report including statistical data may be generated by the execution of the visual model. The report may include a variety of different data, including costing data, resource usage metrics, or any other information available as a result of running the visual model. Rules of a visual model standard (e.g., SYSML) may be utilized in generating the visual model. In response to the user selecting and classifying the elements of the activity based modeling data, data identifying the classified activity based modeling data may be stored. In one embodiment, the data that identifies the activity based modeling data may be reference data that identifies rows and columns, if in a spreadsheet, of the classified elements of the activity based modeling data. In addition, classification identifiers (e.g., “resource,” “activity,” etc.) may be stored in association with the reference data. In one embodiment, the classification identifiers are CAM-I ABCM classifications. Alternative activity based modeling and classifiers may be utilized.

The principles of the present invention provide for a visual modeling toolset to be executed in a personal computer, local server, or “cloud” server as a software-as-a-service solution. With a “cloud” server, requests may be received from computers located over a communications network to read activity based modeling data and process the classified data to generate the visual model. Because the visual model and activity based model may be interconnected by data that provides a relationship between the two models, the models may be synchronized in that when the activity based model in a spreadsheet, for example, is updated, then the visual model may be updated. In one embodiment, the update may be substantially simultaneous. Alternatively, the update may be made periodically or event driven (e.g., user request for an update). Similarly, if a change is made to the visual model, the activity based model may be updated. Alternatively, rather than affecting the original activity based model, the toolset may enable the user to export the visual model data to a new spreadsheet with the same configuration as the original one by using the reference data to position the elements of the activity based model. In importing the activity based model to create the visual model, a transformation identification wizard may be utilized to enable the user to provide inputs (e.g., browse to identify a spreadsheet, identify rows and columns of elements of the activity based model, classify the elements) to pre-established input requests to simply use by the user.

Although the principles of the present invention have been described in terms of the foregoing embodiments, this description has been provided by way of explanation only, and is not intended to be construed as a limitation of the invention. Those skilled in the art will recognize modifications of the principles of the present invention exist. Such modification may include different modules, additional modules, different algorithms, and so forth that provide the same or analogous functionality as described herein.

We claim:

1. A system for transforming activity based modeling into a visual model, comprising:
a storage unit configured to store activity based modeling data;
a processing unit in communication with said storage unit, and configured to:
read the activity based modeling data;
enable a user to classify data as elements of an activity based model;
generate a visual model based on the classified data of the activity based modeling data; and
display the visual model of the classified data of the activity based modeling data.

2. The system according to claim 1, wherein said processing unit is further configured to execute the visual model.

3. The system according to claim 2, wherein said processing unit is further configured to generate a report including statistical data generated by the execution of the visual model.

4. The system according to claim 2, wherein said processing unit is further configured to apply rules of a visual model standard in generating the visual model.

5. The system according to claim 1, wherein said processing unit, in executing the visual model, is configured to execute a simulation utilizing the visual model.

6. The system according to claim 1, wherein said processing unit is further configured to store data identifying the classified activity based modeling data in the storage unit.

7. The system according to claim 6, wherein the stored data includes (i) reference data that references positions of the classified activity based modeling data in a spreadsheet and (ii) classification identifiers of each of the classified data.

8. The system according to claim 7, wherein the classification identifiers are CAM-I ABCM classifications.

9. The system according to claim 1, further comprising an input/output (I/O) unit in communication with said processing unit, and configured to receive requests from remotely located computers over a communications network to read the activity based modeling data and process the classified data to generate the visual model.

10. The system according to claim 1, wherein said processing unit is further configured to update the visual model in response to the user updating the activity based modeling data.

11. The system according to claim 10, wherein updating the visual model is performed substantially real-time.

12. The system according to claim 1, wherein said processing unit is further configured to generate a spreadsheet with a format identical to a format of the activity based modeling data from the visual model.

13. The system according to claim 1, wherein said processing unit is further configured to:
enable the user to change data in the visual model; and
in response to the data in the visual model changing, update results of the visual model.

14. The system according to claim 1, said processing unit, in enabling the user to classify the data as elements of an activity based model, is further configured to:
execute a transformation identification wizard that enables the user to selectively identify locations of the elements; and
classify the elements as types of elements of the activity based model.

15. A method for transforming activity based modeling into a visual model, comprising:
storing, by a storage unit, activity based modeling data;
reading, by a computing unit, the activity based modeling data;
enabling, by the computing unit, a user to classify data as elements of an activity based model;
generating, by the computing unit, a visual model based on the classified data of the activity based modeling data; and
displaying, by the computing unit, the visual model of the classified data of the activity based modeling data.

16. The method according to claim 15, further comprising to executing the visual model.

17. The method according to claim 16, further comprising generating a report including statistical data generated by the execution of the visual model.

18. The method according to claim 16, further comprising applying rules of a visual model standard in generating the visual model.

19. The system according to claim 16, wherein executing the visual model includes executing a simulation utilizing the visual model.

20. The method according to claim 15, further comprising storing data identifying the classified activity based modeling data in the storage unit.

21. The method according to claim 20, wherein storing the data includes storing (i) reference data that references positions of the classified activity based modeling data in a spreadsheet and (ii) classification identifiers of each of the classified data.

22. The method according to claim 21, wherein storing the classification identifiers includes storing CAM-I ABCM classifications.

23. The method according to claim 15, further comprising receiving requests from remotely located computers over a communications network to read the activity based modeling data and process the classified data to generate the visual model.

24. The method according to claim 15, further comprising updating the visual model in response to the user updating the activity based modeling data.

25. The method according to claim 24, wherein updating the visual model is performed substantially real-time.

26. The method according to claim 15, further comprising generating a spreadsheet with a format identical to a format of the activity based modeling data from the visual model.

27. The method according to claim 15, further comprising enabling the user to change data in the visual model; and
in response to the data in the visual model changing, updating results of the visual model.

28. The method according to claim 15, wherein enabling the user to classify the data as elements of an activity based model, includes:
executing a transformation identification wizard that enables the user to selectively identify locations of the elements; and
classifying the elements as types of elements of the activity based model.

29. A system for transforming activity based modeling data into a visual model, said system comprising:
a storage unit configured to store activity based modeling data;
a processing unit in communication with said storage unit, and configured to:
enable a user to select locations of elements of the activity based modeling data being stored;
enable the user to classify each of the elements of the activity based modeling data;
generate the visual model based on the defined locations and classifications of the elements of the activity based modeling data; and
display the visual model.

30. The system according to claim 27, wherein said processing unit is further configured to display a graphical user interface that enables the user to select starting and ending rows and columns of the elements of the activity based modeling data.

31. The system according to claim 28, wherein said processing unit is further configured to display selectable classifiers to associate with each element being classified by the user.

32. The system according to claim 27, wherein said processing unit is further configured to enable the user to select an activity element from among a plurality of activity elements displayed in a list and, in response, display a portion of the visual model that includes the selected activity element and visual model elements associated with the selected activity element.
